(19) United States
(12) Patent Application Publication
(10) Pub. No.: US 2016/0083274 A1
(43) Pub. Date: Mar. 24, 2016

(54) Applications of the Radial Deionization (RDI) Device and System and Techniques for Device & System Operation

(71) Applicant: ATLANTIS TECHNOLOGIES, Dana Point, CA (US)

(72) Inventor: Patrick Michael Curran, Laguna Niguel, CA (US)

(21) Appl. No.: 14/120,498

(22) Filed: May 27, 2014

(51) Int. Cl. C02F 1/469; C02F 1/461

(52) U.S. Cl. CPC C02F 1/4691; C02F 1/46104

(57) ABSTRACT

This invention relates to a radial deionization device and system that can be used to remove dissolved solids from a liquid such as water, acid, aqueous or non-aqueous, and the potential applications of such a device along with unique and unobvious operational techniques.

### CROSS-REFERENCE TO RELATED APPLICATIONS

This application claims the benefit of provisional patent application Ser. No. 61/855,771 filed 2013 May 24 by the present inventor.

### FEDERALLY SPONSORED RESEARCH Not applicable

### SEQUENCE LISTING OR PROGRAM Not applicable

### BACKGROUND OF INVENTION

1. Field of Invention

This invention relates to a radial deionization device and system that can be used to remove dissolved solids from a liquid such as water, acid, aqueous or non-aqueous, and the potential applications of such a device along with unique and unobvious operational techniques.

A radial deionization device and system, as described in U.S. patent application Ser. No. 12/807,540, is a form of capacitive deionization. A solution containing dissolved solids is passed between the two charged capacitor layers of an electric double layer capacitor (EDLC). The cations are adsorbed by the negatively charged capacitor layer and the anions by the negatively charged layer. Once the removal rate of ions from solution falls below process requirement, the polarity of the capacitor is switched and the adsorbed ions are ejected into the flow channel and removed from the device.

This invention relates to the types of solutions that can be processed by the device and the techniques of device operation. Due to the unique design and operation, we have developed very techniques that are very unique to commercially available deionizing systems.

2. Objects and Advantages

Accordingly, several objects and advantages of our invention are:
Applications
a) Deionizing of fracture and produced water from oil and gas industry.
b) Deionizing sea water and brackish water.
c) Metal removal from acids and base streams such as sulfuric acid.
d) Concentrating of bases, acids, and other high solubility species such as but not limited to sulfuric acid, sodium sulfate, sodium chloride, and sodium hydroxide.
e) Heavy metal removal such as but not limited to selenium, mercury, arsenic, antimony, uranium, lead, radium, etc.
f) Metal concentration
   a. Rare earths
   b. Premium/semi precious (i.e. nickel sulfate).
   c. Precious (i.e. gold solutions).
g) Low solubility specie removal and concentration above saturation.
h) Renewable energy deionization such as self contained solar powered desalination systems.
i) Mining water deionizing, including mine drainage runoff remediation.
j) Deionizing reject water from other water systems such as reverse osmosis and brine concentrators.
k) Deionizing cooling tower water.
l) Removal or difficult species such as but not limited to nitrates, silica, phosphates, carbonates, calcium sulfate, barium sulfate, and strontium sulfate.
m) Deionizing of high salinity streams that are outside the operating range of any existing deionizing system such as solutions containing over 500 to 350,000 ppm sodium chloride fracture, produced, industrial, or mining solutions.
n) Deionizing water streams from power plant scrubbers such as spent gypsum slurry, flue gas desulfurization, cooling tower blow down.
o) Treatment of high temperature fluids including saline solutions from 0 to over 100 celsius.
p) Pre-treatment concentration for brine concentrator or crystallizer.
q) Treatment of waste water from agriculture such as green houses by removal of nitrates, phosphates, carbonates, metals, etc.
r) In combination with a forward osmosis system.
s) As a desalination system for a spacecraft.
Radial Deionization Operational Techniques
a) Use compressed air to psh the rejected ions out of the device to conserve water and maximize the concentration of reject solution.
b) Shut off flow of liquid during all or most of the reject cycle so as to conserve water and maximize the concentration of reject solution.
c) Adjust the power supply voltage output based on actual voltage across the cell(s).
   a. Apply maximum voltage during cycle so as to minimize capacitor charging time.
   b. Remove power supply from circuit when polarity is switch and re-engage at appropriate time in the charging cycle.
   c. Operate system above 1.0 volts, including up to 4.0 volts and above.
d) Adjust the thickness of the carbon electrode so as to maximize the concentration of the rejected solution.
e) Use of a combination of monovalent and multivalent membranes to selectively deionize specific species from a process stream.
f) Introduce another stream during the reject cycle such as previously cleaned water or deionized water.
g) Adjust pH of inlet and outlet solutions so as to isolate ions based on valence and charge changes.
h) Flush system forward or backward.
i) Adjust pH of inlet to maximize removal of silica and other species.
j) Use of ion selective membranes to selectively remove certain species.

### SUMMARY

This invention relates to the applications and unique operational techniques of the radial deionization device and system.

### DRAWINGS—FIGURES

FIG. 1: Combination of radial deionization system for forward osmosis.

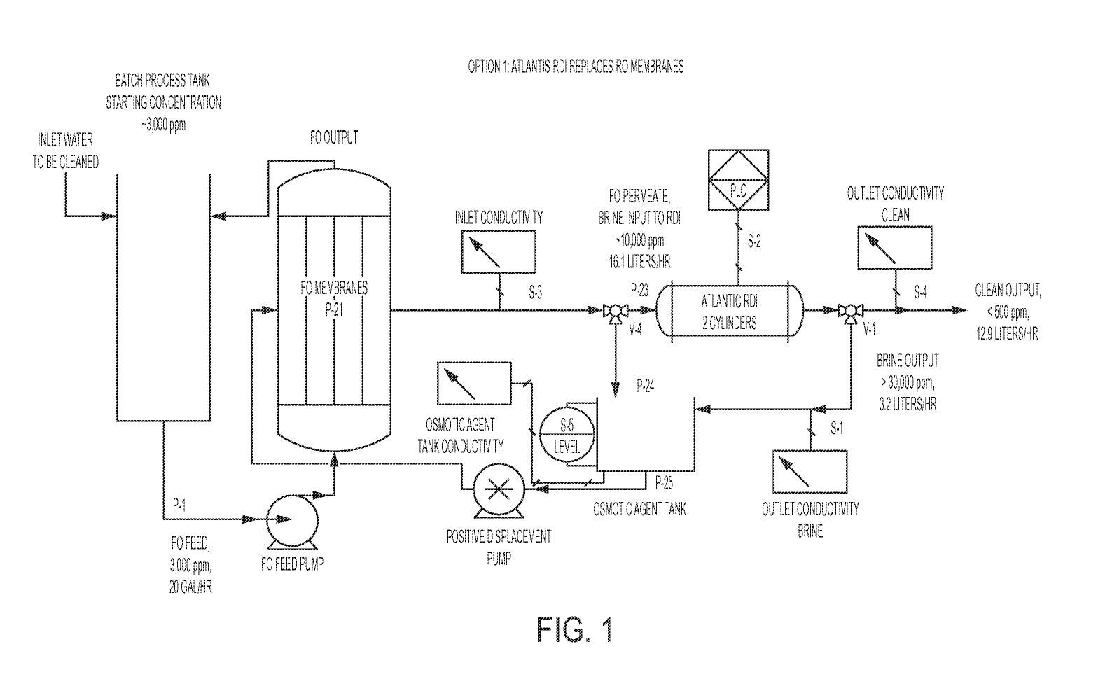

FIG. 2: Full radial deionization system with pump, power supply, plumbing, electrical, compressed air, etc.

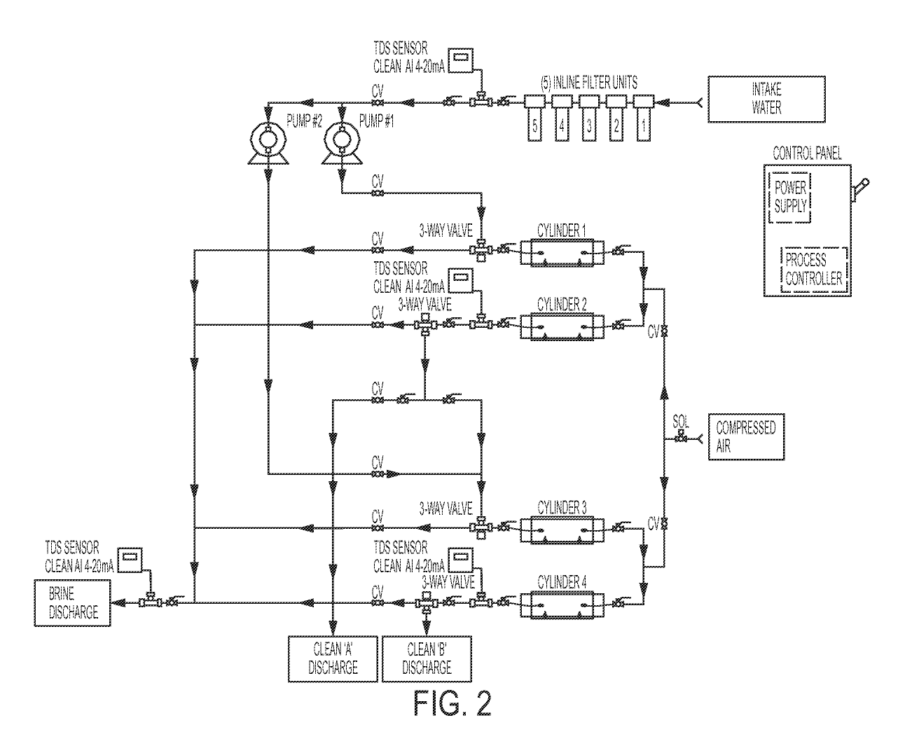

FIG. 3: Diagram of 3 cylinders in series.

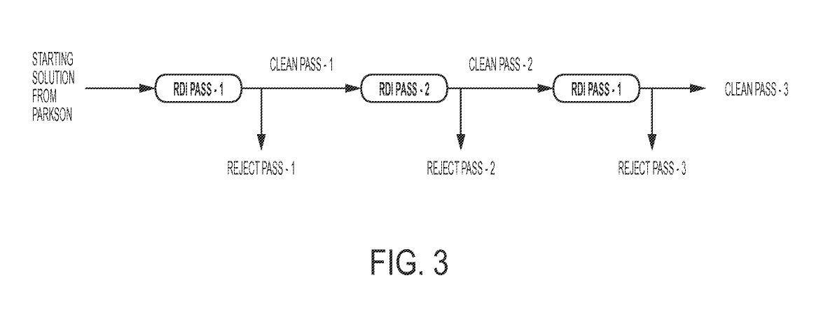

### DETAILED DESCRIPTION OF THE INVENTION & EXAMPLES

Applications

a) Deionizing of fracture and produced water from oil and gas industry.
More water is produced by the oil industry than oil itself. The water is contaminated with many species, including high levels of dissolved solids. The energy required to deionize these waste water streams with state of the art technologies is very high, and in many cases, can not be processed. The RDI system can process these water streams with 25-75% less energy, process difficult species, and process streams with total dissolved solids (tds) greater than 250,000 ppm, outside the range of brine concentrators.

b) Deionizing sea water and brackish water.
Sea water and other solutions containing primarily sodium chloride can be deionized with lower energy than current technologies.

c) Metal removal from acids streams such as sulfuric acid.
By configuring the RDI device with cationic membranes, heavy metals can be removed without removing the anionic species. For example, lead, antimony, and arsenic can be removed from contaminated sulfuric acid, leaving behind cleaned acid.

d) Concentrating of bases, acids, and other high solubility species such as but not limited to sulfuric acid, sodium sulfate, sodium chloride, and sodium hydroxide.
The RDI device can effectively remove acids (such as sulfuric) bases (sodium hydroxide) and high solubility species (sodium chloride) from solution. When rejected from the device, the solutions created can be up to 20 times the concentration of the original solution. For example, a 0.5% solution of sulfuric acid was processed and concentrated by a factor of 4 with minimal effort.

e) Heavy metal removal.
Remove heavy, rare earth, radioactive, low concentration, and multivalent metals. The RDI device can reduce the concentration of these metals in a similar percentage as the overall TDS reduction. This includes metals that are originally in solution at concentrations in the parts per billion and trillion range.
f) Metal Concentration
   a. Rare earths
   b. Premium/semi precious (nickel sulfate).
   c. Precious (gold solutions).
   The RDI device can effectively remove dissolved solids from solution such as but not limited to the ions of gold, nickel, lanthanum. When combined with techniques to maximize the concentration of the rejected stream, these previously dilute streams can be concentrated to an economical level.

g) Low solubility specie removal and concentration above saturation maximum.
Because of the short residence time within the device and cyclical cleaning nature of a EDLC, species with low solubility limits can be purified and concentrated well beyond solubility limits. For example, calcium sulfate at double saturation was processed by the RDI system, producing clean water and super saturated solution at six times saturation.

h) Renewable energy deionization such as self contained solar powered desalination systems.
Because the state of the art technologies are very inefficient at low flow rates, the renewable energy systems (solar, wind) required to power them are proportionally large. The cost of the energy system is typically four times greater than the cost of the water system. The RDI system is energy efficient at low and high flow rates and is up to 75% more energy efficient at low flow rates than reverse osmosis. Consequently, the renewable energy system required to power the RDI system is ¼ of the price that needed for RO. The combined system price is greater than 25% less than the equivalent RO system.

i) Mining water deionizing, including mine drainage runoff remediation.
Waste water generated by the mining industry, including water directly from the mine or contaminated water generated by the exposure of unearthed minerals from the mine, can be processed through the RDI device and system regardless of the type of ions dissolved in solution or pH. For example, sulfite based minerals produce sulfuric acid when exposed to air and water at the surface. This acidic solution then dissolves materials from the local materials. This solution can be deionized producing clean water and concentrated waste for disposal.

j) Deionizing reject water from other water systems such as reverse osmosis (RO) and brine concentrators.
Many industrial and municipal customers process water through existing technologies and generate waste water with very high tds. This water can not be economically reprocessed by the existing system. The RDI device and system and be utilized to further clean the water and generate additional clean water and more concentrated reject for disposal. For example, a 5,000 ppm solution from a nano-filtration system was processed by the RDI device, producing drinking water and further concentrated solution.

k) Deionizing cooling tower water.
Most cooling towers require some type of softening system to remove hardness (calcium and magnesium). In some parts of the world, the commercially available water also contains difficult to remove and problematic species such as silica. The RDI device and system can be used to remove hardness and difficult ions. For example, there is approximately 300 ppm of silica in the ground water in New Mexico and causes significant problems with operating cooling towers. The silica can be reduced below a level that causes problems.

l) Removal or difficult species such as but not limited to nitrates, silica, uranium, calcium sulfate, barium sulfate, and strontium sulfate.
Any dissolved solid can be removed from aqueous solution with the RDI device and system. This includes but is not limited to the cations and anions of arsenic, barium sulfate, calcium sulfate, antimony, lead, cadmium, sulfates, sulfites, carbonates, phosphates, fluoride, chlorides, sodium, lithium, cesium, potassium, magnesium, radium, strontium, gold, silver, palladium, platinum, lanthanum, cerium, iron, nickel, copper, chrome, tin, and bromides. For example, nitrates in farm runoff can be removed and the treated water reused.

m) Deionizing of high salinity streams that are outside the operating range of any existing deionizing system such as 300,000 ppm sodium chloride fracture, produced, industrial, or mining solutions.
The maximum tds RO can process is 60,000 ppm and 250,000 ppm for brine concentrator. Because of the design of the RDI device and system, high salinity streams can be processed. This is very advantageous in the oil/gas produced water and mining water industry. For example, a solution of 300,000 ppm sodium chloride was deionized producing a lower tds clean solution and concentrated reject. This tds level can not be process by any other existing technology.

n) Deionizing water streams from power plant scrubbers such as spent gypsum slurry.
The RDI can desalinate/deionize FGD scrubber flow down and remove the calcium chloride, calcium sulfates, other low solubility species in addition to heavy metal contaminants such as but not limited to mercury and selenium. Generating a clean water for reuse and brine for proper treatment and disposal. The system can also desalinate the cooling tower blow down water and generate clean water for reuse and brine for disposal.

o) Treatment of high temperature fluids including saline solutions from 0 to over 100 Celsius.
The system can process liquid water with temperatures up to and above 100 degrees Celsius.

p) Pre-treatment concentration for brine concentrator or crystallizer.
Because of the ability to process water up to and above 100 Celsius the RDI system can be used as an intermediate step in a ZLD process.

q) Treatment of waste water from agriculture such as farms and green houses by removal of nitrates, phosphates, carbonates, metals, etc.
Because of the ability to remove all salts, the RDI system can be used to process waste water and other streams generated by any agriculture operation including open land, green house, hydroponic, etc.

r) In combination with a forward osmosis system (FO).
Because of the ability to dewater a solution, the system can be used in conjunction with a forward osmosis system (FO) to dewater the FO permeate and generate reusable osmotic agent for operation of the FO system.

s) As a desalination system for a spacecraft.
Because of the ability to remove low solubility salts such as those present in spacecraft waste water such as calcium sulfate and calcium carbonate and operate on DC power and low energy, the RDI system is ideal for waste water processing on spacecraft or airplanes which much recycle some portion of their water.

Radial Deionization Operational Techniques

a) Use compressed air to push the rejected ions out of the device to conserve water and maximize the concentration of reject solution.
Once the purification cycle is complete and the polarity is reverse to eject the capture ions out of the device, the process liquid flow is stopped. Near the end of the reject cycle, air is pumped through the RDI device removing the highly concentrated rejected liquid and ions. This greatly increases the level of concentrating and increases the liquid recovery of the system. For example, a solution of 5,000 ppm sulfuric acid was concentrated further by pumping air through the device.

b) Shut off flow of liquid during the majority of the reject cycle so as to conserve water and maximize the concentration of reject solution.
Flow is shut off during the majority of the reject cycle, maximizing recovery and concentrating capability. This technique is used on most cycle protocols of the RDI device and system.

c) Adjust the power supply voltage output based on actual voltage across the cell(s).
a. Apply maximum voltage during cycle so as to minimize capacitor charging time.
The charging rate during the cleaning and reject cycles is slightly different. The charging rates can be adjusted up or down by using cell voltage feedback and adjust the output voltage of power supply. For example, if not adjusted, the maximum voltage reached during the purification cycle is 10% less than during the reject. The power supply output is adjusted during the cleaning cycle so that the max target voltage is reached as quickly as possible.
b. Remove power supply from circuit when polarity is switch and re-engage at appropriate time in the charging cycle.
When the cleaning cycle is complete and the polarity is switched, a large current is observed. This energy transfer from one side of the RDI device to the other is free energy and should flow uninhibited until the rate of charging falls below expectations. The free flowing current bypasses the power supply. When current falls below expectations, the power supply is re-engaged. This technique conserves energy and increases the efficiency of the system. For example, there is an inrush of current during the first minute after polarity switch. If this current runs through the power supply, the apparent energy usage to clean the process stream is artificially increased. When allowed to bypass the power supply for the first minute and then engage, the calculated energy usage is 50% less.

d) Adjust the thickness of the carbon electrode so as to maximize the concentration of the rejected solution.
The more ions that are held within the capacitor during cleaning, the larger the concentrating capability. In this case, the carbon electrode thickness is increased to allow for more ions to be adsorbed per square area of electrode. For example, the electrode thickness can be doubled from 0.010″ to 0.020″ allowing for twice as many ions to be held by the capacitor. Since the water contained within carbon electrode is brought into the capacitor as hydrated molecules surrounding the cation or anion, a higher concentration reject can be produced.

e) Use of a combination of monovalent and multivalent membranes to selectively deionize specific species from a process stream.
If the RDI device is operated with monovalent cationic and anionic membranes, only monovalent ions are removed during the cleaning mode. This allows for preferential removal of monovalent, leaving behind divalent and higher order ions. Conversely, the device can be operated with only divalent membranes, or a combination of the two depending on the makeup of the solution. For example, there are cases were monovalent cations are coupled with divalent anions. A system could be used to preferentially remove one of the partner ions. For example, a solution containing calcium, magnesium will be softened by separating the sodium ions from the calcium and magnesium. This allows for water softening without use of chemicals or use of resin beads and addition of extra sodium chloride to the water system.

f) Introduce another stream during the reject cycle such as deionized water.
Another process stream can be introduced during part or all of the reject cycle to transfer the removed ions to another stream. For example, deionized water could be used and a solution made up of only the removed ions could be formulated.

g) Adjust pH of inlet and outlet solutions so as to isolate ions based on valence and charge changes.
Many ions change the valence number with changes in pH. Some species actual change from cationic to anionic. This phenomenon can be exploited to perform selective removal of one or more species with the RDI device in possible combination with charge specific membranes. For example, arsenic and antimony valence number and polarity can be changed if pH of solution is increased.

1. Use the radial deionization system for deionizing of wed and or generated in the oil, gas, mining, municipal and power generation industry.
